(19) United States
(12) Patent Application Publication
(10) Pub. No.: US 2010/0275878 A1
(43) Pub. Date: Nov. 4, 2010

(54) SPLIT-CYCLE ENGINE WITH DUAL SPRAY TARGETING FUEL INJECTION

(75) Inventor: Ford Phillips, San Antonio, TX (US)

Correspondence Address: FILDES & OUTLAND, P.C., 20916 MACK AVENUE, SUITE 2, GROSSE POINTE WOODS, MI, 48236, US

(73) Assignee: Scuderi Group, LLC, West Springfield, MA (US)

(21) Appl. No.: 12/767,848

(22) Filed: Apr. 27, 2010

Related U.S. Application Data
(60) Provisional application No. 61/215,146, filed on May 1, 2009.

(51) Int. Cl. F02B 3/00; F02B 33/22; F02B 25/00; F02B 31/00

(52) U.S. Cl. 123/299; 123/70 R; 123/65 W; 123/301

(57) ABSTRACT

An engine includes a rotatable crankshaft and an expansion piston slidably received within an expansion cylinder and operatively connected to the crankshaft. A crossover passage including walls connects a source of high pressure gas to the expansion cylinder. A crossover expansion (XovrE) valve is operable to control fluid communication between the crossover passage and the expansion cylinder. The XovrE valve includes a valve head and a valve stem extending from the valve head. A fuel injector operable to inject fuel into the crossover passage includes a plurality of spray holes disposed in a nozzle end and aimed at an at least one target at which fuel emitting from the spray holes is directed to form at least one spray pattern. The at least one target is located above a seated position of the XovrE valve head and between the walls of the crossover passage and the XovrE valve stem.

### CROSS REFERENCE TO RELATED APPLICATION

This application claims the benefit of U.S. Provisional Application No. 61/215,146, filed May 1, 2009 and titled: Split-Cycle Engine with Dual Spray Targeting Fuel Injection.

### TECHNICAL FIELD

The present invention relates to internal combustion engines. More specifically, the present invention relates to a split-cycle engine having fuel injectors which produce dual spray patterns.

### BACKGROUND OF THE INVENTION

For purposes of clarity, the term “conventional engine” as used in the present application refers to an internal combustion engine wherein all four strokes of the well-known Otto cycle (the intake, compression, expansion and exhaust strokes) are contained in each piston/cylinder combination of the engine. Each stroke requires one half revolution of the crankshaft (180 degrees crank angle (CA)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage interconnecting the compression and expansion cylinders, the crossover passage including a crossover compression (XovrC) valve and a crossover expansion (XovrE) valve defining a pressure chamber therebetween.

U.S. Pat. No. 6,543,225 granted Apr. 8, 2003 to Carmelo J. Scuderi (the Scuderi patent) and U.S. Pat. No. 6,952,923 granted Oct. 11, 2005 to David P. Branyon et al. (the Branyon patent) each contains an extensive discussion of split-cycle and similar type engines. In addition, the Scuderi and Branyon patents disclose details of prior versions of engines of which the present invention comprises a further development. Both the Scuderi patent and the Branyon patent are incorporated herein by reference in their entirety.

Referring to FIG. 1, a prior art split-cycle engine of the type similar to those described in the Branyon and Scuderi patents is shown generally by numeral 8. The split-cycle engine 8 replaces two adjacent cylinders of a conventional engine with a combination of one compression cylinder 12 and one expansion cylinder 14. A cylinder head 33 is typically disposed over an open end of the expansion and compression cylinders 12, 14 to cover and seal the cylinders.

The four strokes of the Otto cycle are “split” over the two cylinders 12 and 14 such that the compression cylinder 12, together with its associated compression piston 20, perform the intake and compression strokes, and the expansion cylinder 14, together with its associated expansion piston 30, perform the expansion and exhaust strokes. The Otto cycle is therefore completed in these two cylinders 12, 14 once per crankshaft 16 revolution (360 degrees CA) about crankshaft axis 17.

During the intake stroke, intake air is drawn into the compression cylinder 12 through an intake port 19 disposed in the cylinder head 33. An inwardly opening (opening inward into the cylinder) poppet intake valve 18 controls fluid communication between the intake port 19 and the compression cylinder 12.

During the compression stroke, the compression piston 20 pressurizes the air charge and drives the air charge into the crossover passage (or port) 22, which is typically disposed in the cylinder head 33. This means that the compression cylinder 12 and compression piston 20 are a source of high pressure gas to the crossover passage 22, which acts as the intake passage for the expansion cylinder 14. In some embodiments, two or more crossover passages interconnect the compression cylinder 12 and the expansion cylinder 14.

The volumetric compression ratio of the compression cylinder 12 of split-cycle engine 8 (and for split-cycle engines in general) is herein referred to as the “compression ratio” of the split-cycle engine. The volumetric compression ratio of the expansion cylinder 14 of split-cycle engine 8 (and for split-cycle engines in general) is herein referred to as the “expansion ratio” of the split-cycle engine. The volumetric compression ratio of a cylinder is well known in the art as the ratio of the enclosed (or trapped) volume in the cylinder (including all recesses) when a piston reciprocating therein is at its bottom dead center (BDC) position to the enclosed volume (i.e., clearance volume) in the cylinder when the piston is at its top dead center (TDC) position. Specifically for split-cycle engines as defined herein, the compression ratio of a compression cylinder is determined when the XovrC valve is closed. Also, specifically for split-cycle engines as defined herein, the expansion ratio of an expansion cylinder is determined when the XovrE valve is closed.

Due to very high compression ratios (e.g., 20 to 1, 30 to 1, 40 to 1, or greater), an outwardly opening (opening outward away from the cylinder) poppet crossover compression (XovrC) valve 24 at the crossover passage inlet 25 is used to control flow from the compression cylinder 12 into the crossover passage 22. Due to very high expansion ratios (e.g., 20 to 1, 30 to 1, 40 to 1, or greater), an outwardly opening poppet crossover expansion (XovrE) valve 26 at the outlet 27 of the crossover passage 22 controls flow from the crossover passage 22 into the expansion cylinder 14. The actuation rates and phasing of the XovrC and XovrE valves 24, 26 are timed to maintain pressure in the crossover passage 22 at a high minimum pressure (typically 20 bar absolute or higher during full load operation) during all four strokes of the Otto cycle.

At least one fuel injector 28 injects fuel into the pressurized air at the exit end of the crossover passage 22 in correspondence with the XovrE valve 26 opening, which occurs shortly before expansion piston 30 reaches its top dead center position. The air/fuel charge usually enters the expansion cylinder 14 shortly after expansion piston 30 reaches its top dead center position (TDC), although it may begin entering slightly before TDC under some operating conditions. As piston 30 begins its descent from its top dead center position, and while the XovrE valve 26 is still open, spark plug 32, which includes a spark plug tip 39 that protrudes into cylinder 14, is fired to initiate combustion in the region around the spark plug tip 39. Combustion can be initiated while the expansion piston is between 1 and 30 degrees CA past its top dead center (TDC) position. More preferably, combustion can be initiated while the expansion piston is between 5 and 25 degrees CA past its top dead center (TDC) position. Most preferably, combustion can be initiated while the expansion piston is between 10 and 20 degrees CA past its top dead center (TDC) position. Additionally, combustion may be initiated through other ignition devices and/or methods, such as with glow plugs, microwave ignition devices or through compression ignition methods.

The XovrE valve 26 is closed after combustion is initiated but before the resulting combustion event can enter the crossover passage 22. The combustion event drives the expansion piston 30 downward in a power stroke.

During the exhaust stroke, exhaust gases are pumped out of the expansion cylinder 14 through exhaust port 35 disposed in cylinder head 33. An inwardly opening poppet exhaust valve 34, disposed in the inlet 31 of the exhaust port 35, controls fluid communication between the expansion cylinder 14 and the exhaust port 35.

With the split-cycle engine concept, the geometric engine parameters (i.e., bore, stroke, connecting rod length, volumetric compression ratio, etc.) of the compression 12 and expansion 14 cylinders are generally independent from one another. For example, the crank throws 36, 37 for the compression cylinder 12 and expansion cylinder 14, respectively, may have different radii and may be phased apart from one another such that top dead center (TDC) of the expansion piston 30 occurs prior to TDC of the compression piston 20. This independence enables the split-cycle engine 8 to potentially achieve higher efficiency levels and greater torques than typical four stroke engines.

The geometric independence of engine parameters in the split-cycle engine 8 is also one of the main reasons why pressure can be maintained in the crossover passage 22 as discussed earlier. Specifically, the expansion piston 30 reaches its top dead center position prior to the compression piston reaching its top dead center position by a discreet phase angle (typically between 10 and 30 crank angle degrees). This phase angle, together with proper timing of the XovrC valve 24 and the XovrE valve 26, enables the split-cycle engine 8 to maintain pressure in the crossover passage 22 at a high minimum pressure (typically 20 bar absolute or higher during full load operation) during all four strokes of its pressure/volume cycle. That is, the split-cycle engine 8 is operable to time the XovrC valve 24 and the XovrE valve 26 such that the XovrC and XovrE valves are both open for a substantial period of time (or period of crankshaft rotation) during which the expansion piston 30 descends from its TDC position towards its BDC position and the compression piston 20 simultaneously ascends from its BDC position towards its TDC position. During the period of time (or crankshaft rotation) that the crossover valves 24, 26 are both open, a substantially equal mass of gas is transferred (1) from the compression cylinder 12 into the crossover passage 22 and (2) from the crossover passage 22 to the expansion cylinder 14. Accordingly, during this period, the pressure in the crossover passage is prevented from dropping below a predetermined minimum pressure (typically 20, 30, or 40 bar absolute during full load operation). Moreover, during a substantial portion of the intake and exhaust strokes (typically 90% of the entire intake and exhaust strokes or greater), the XovrC valve 24 and XovrE valve 26 are both closed to maintain the mass of trapped gas in the crossover passage 22 at a substantially constant level. As a result, the pressure in the crossover passage 22 is maintained at a predetermined minimum pressure during all four strokes of the engine's pressure/volume cycle.

XovrE valve 26 opens shortly before the expansion piston 30 reaches its top dead center position. At this time, the pressure ratio of the pressure in crossover passage 22 to the pressure in expansion cylinder 14 is high, due to the fact that the minimum pressure in the crossover passage is typically 20 bar absolute or higher at full engine load and the pressure in the expansion cylinder during the exhaust stroke is typically about one to two bar absolute. In other words, when XovrE valve 26 opens, the pressure in crossover passage 22 is substantially higher than the pressure in expansion cylinder 14 (typically in the order of 20 to 1 or greater at full engine load). This high pressure ratio causes initial flow of the air and/or fuel charge to flow into expansion cylinder 14 at high speeds. These high flow speeds can reach the speed of sound, which is referred to as sonic flow. This sonic flow is particularly advantageous to split-cycle engine 8 because it causes a rapid combustion event, which enables the split-cycle engine 8 to maintain high combustion pressures even though ignition is initiated while the expansion piston 30 is descending from its top dead center position.

The fuel injectors 28 have a plurality of spray holes disposed in the nozzle end of the fuel injectors 28 which are targeted to produce one or more generally conical spray patterns. However, various parameters of the fuel injectors 28 and spray hole targeting are critical for assuring the proper delivery of fuel to the expansion cylinder, wherein variations in these parameters can result in less than optimal fuel delivery. Some of these parameters include, but are not limited to, the number and size (i.e., diameter) of spray holes, the number and location of the spray hole targets of the spray holes, injector operating pressures and temperatures, fuel droplet size produced by the spray holes, and the timing of the injectors.

### SUMMARY OF THE INVENTION

The present invention provides an apparatus for and method of injecting fuel into an engine wherein spray holes of the engine's fuel injectors are aimed at certain targets to produce fuel sprays that enhance engine performance.

More particularly, an exemplary embodiment of an engine in accordance with the present invention includes a crankshaft rotatable about a crankshaft axis. An expansion piston is slidably received within an expansion cylinder and operatively connected to the crankshaft such that the expansion piston is operable to reciprocate through an expansion stroke and an exhaust stroke during a single rotation of the crankshaft. A crossover passage including walls connects a source of high pressure gas to the expansion cylinder. A crossover expansion (XovrE) valve is operable to control fluid communication between the crossover passage and the expansion cylinder. The XovrE valve includes a valve head and a valve stem extending from the valve head. A fuel injector is operable to inject fuel into the crossover passage. The fuel injector includes a plurality of spray holes disposed in a nozzle end of the fuel injector and aimed at an at least one target at which fuel emitting from the spray holes is directed to form at least one spray pattern. The at least one target is located above a seated position of the XovrE valve head and between the walls of the crossover passage and the XovrE valve stem.

The XovrE valve may be an outwardly opening valve. The spray holes may be aimed at a plurality of spray targets to form a plurality of spray patterns, the targets being located such that the spray patterns straddle the valve stem of the XovrE valve. Each spray hole may have a centerline extending therethrough, the plurality of spray holes being oriented such that the spray hole centerlines pass through the at least one target at which fuel emitting from the spray holes are aimed. One of the at least one target may be an outside diameter target located at a point on the centerline of one spray hole of the plurality of spray holes at which the centerline intersects a maximum outside diameter of the XovrE valve head when the XovrE valve is raised a predetermined target lift distance above its seated position. The target lift distance may be within a range of 10 to 60 percent of maximum XovrE valve lift, preferably 15 to 40 percent of maximum XovrE valve lift, and more preferably 20 to 30 percent of maximum XovrE valve lift.

The spray hole centerlines may be substantially independently oriented. The number of spray patterns may equal the number of spray targets.

The crossover passage may be a helical crossover passage including a helical end section disposed over the XovrE valve. The at least one target may be located within the helical end section. The helical end section may spiral in one of a clockwise or a counterclockwise direction.

The source of high pressure gas may be a compression cylinder including a compression piston slidably received therein, the compression cylinder being operatively connected to the crankshaft such that the compression piston is operable to reciprocate through an intake stroke and a compression stroke during a single rotation of the crankshaft. The crossover passage interconnects the expansion and compression cylinders.

In another exemplary embodiment, an engine in accordance with the present invention includes a crankshaft rotatable about a crankshaft axis. An expansion piston is slidably received within an expansion cylinder and operatively connected to the crankshaft such that the expansion piston is operable to reciprocate through an expansion stroke and an exhaust stroke during a single rotation of the crankshaft. A crossover passage connects a source of high pressure gas to the expansion cylinder. A crossover expansion (XovrE) valve is operable to control fluid communication between the crossover passage and the expansion cylinder. The XovrE valve includes a valve stem. A fuel injector is operable to inject fuel into the crossover passage. The fuel injector includes a plurality of spray holes disposed in a nozzle end of the fuel injector. The spray holes are aimed at two or more targets at which fuel emitting from the spray holes is directed to form at least two fuel sprays. The at least two fuel sprays straddle the valve stem of the XovrE valve.

Each spray hole may have a centerline extending therethrough. The plurality of spray holes may be oriented such that each spray hole centerline passes through one of the targets at which fuel is directed. The centerlines of the spray holes forming one of the spray patterns may be oriented at a target that is distinct from a target at which the centerlines of the spray holes forming another of the spray patterns are oriented.

The XovrE valve may include a valve head disposed at an end of the valve stem. The XovrE valve also may be an outwardly opening valve. One of the targets may be an outside diameter target located at a point on the centerline of at least one of the spray holes at which the centerline intersects a maximum outside diameter of the XovrE valve head when the XovrE valve is raised a predetermined target lift distance above its seated position. The target lift distance may be within a range of 10 to 60 percent of maximum XovrE valve lift, preferably 15 to 40 percent of maximum XovrE valve lift, and more preferably 20 to 30 percent of maximum XovrE valve lift.

The crossover passage may be a helical crossover passage including a helical end section disposed over the XovrE valve. The two or more targets may be located within the helical end section. The helical end section may spiral in one of a clockwise or a counterclockwise direction.

The source of high pressure gas may be a compression cylinder including a compression piston slidably received therein, the compression cylinder being operatively connected to the crankshaft such that the compression piston is operable to reciprocate through an intake stroke and a compression stroke during a single rotation of the crankshaft. The crossover passage interconnects the expansion and compression cylinders.

In another exemplary embodiment, a method of injecting fuel in an engine is disclosed. The engine includes a crankshaft rotatable about a crankshaft axis. An expansion piston is slidably received within the expansion cylinder and operatively connected to the crankshaft such that the expansion piston is operable to reciprocate through an expansion stroke and an exhaust stroke during a single rotation of the crankshaft. A crossover passage including walls connects a source of high pressure gas to the expansion cylinder. A crossover expansion (XovrE) valve is disposed at an outlet end of the crossover passage and is operable to control fluid communication between the crossover passage and the expansion cylinder. The XovrE valve includes a valve head and a valve stem extending from the valve head. A fuel injector is operable to inject fuel into the crossover passage. The fuel injector includes a plurality of spray holes disposed in a nozzle end of the fuel injector. Each spray hole is aimed at one of two targets at which fuel emitting from the spray holes is directed to form two spray patterns. The two targets are located above a seated position of the XovrE valve head and between walls of the crossover passage and the XovrE valve stem such that the spray patterns straddle the XovrE valve stem. Injection of fuel is begun from the fuel injector towards the outlet end of the crossover passage. The XovrE valve is opened. Injection of fuel is ended prior to closing the opened XovrE valve.

The XovrE valve may be opened outwardly relative to the expansion cylinder. Fuel injection may be begun before opening the XovrE valve or after opening the XovrE valve. The method may further include the steps of establishing air flow from the crossover passage to the expansion cylinder through the open XovrE valve; sweeping the two spray patterns into the air flow such that one of the spray patterns is pulled over and across the XovrE valve stem and is merged with the other spray pattern to generally form a single combined spray; and pulling the combined spray towards an edge of the outlet end of the crossover passage whereby the combined spray exits the crossover passage through the XovrE valve. The duration of an injection event from the beginning of fuel injection to the ending of fuel injection may be approximately 45 degrees of crank angle or less, preferably 40 degrees of crank angle or less, and more preferably 35 degrees of crank angle or less.

These and other features and advantages of the invention will be more fully understood from the following detailed description of the invention taken together with the accompanying drawings.

### BRIEF DESCRIPTION OF THE DRAWINGS

In the drawings:

FIG. 1 is a cross-sectional view of a conventional split-cycle engine;

FIG. 2 is a perspective view of a helical passage for linking an inlet manifold to an inlet valve of an engine cylinder head;

FIG. 3 is another perspective view of the helical passage;

FIG. 4 is a cross-sectional view of an exemplary embodiment of a split-cycle engine in accordance with the present invention taken along the line 4-4 in FIG. 5;

FIG. 5 is a plan view of the split-cycle engine of FIG. 4;

FIG. 6 is a perspective view of a portion of the split-cycle engine illustrating an inside of a cylinder head and passages of the engine;

FIG. 7 is a perspective view of a fuel injector of the split-cycle engine;

FIG. 8 is an enlarged front view of the fuel injector as viewed from the line 8-8 in FIG. 7;

FIG. 9 is a cross-sectional view of the fuel injector taken along the line 9-9 in FIG. 8;

FIG. 10 is a perspective view of the fuel injector illustrating fuel spray patterns formed by ejecting fuel through spray holes of the injector;

FIG. 11 is a perspective view of a portion of the split-cycle engine illustrating injection of fuel into the engine passages;

FIG. 12 is a perspective view illustrating a Y-X plane of a three-dimensional Cartesian coordinate system superimposed over an expansion cylinder of the engine;

FIG. 13 is a cross-sectional view taken along the line 13-13 in FIG. 12 illustrating a Y-Z plane of the three-dimensional Cartesian coordinate system;

FIG. 14 is a cross-sectional view taken along the line 14-14 in FIG. 12;

FIG. 15 is an exemplary embodiment of a spray target location plot illustrating the Cartesian coordinates of outer diameter (OD) targets and firedeck targets;

FIG. 16 is a plan view of a portion of the split-cycle engine illustrating an inside of the expansion cylinder and associated passages of the engine;

FIG. 17 is a plan view of the engine of FIG. 16 schematically illustrating the beginning of injection of fuel spray into helical end sections of the engine crossover passages;

FIG. 18 is a plan view schematically illustrating the opening of engine valves in the passages such that air flow in the passages begins to affect the trajectory of the fuel sprays;

FIG. 19 is a plan view schematically illustrating distortion of the trajectory of the fuel sprays as they are swept into the air flow;

FIG. 20 is a plan view schematically illustrating fuel sprays being pulled across a valve stem and beginning to merge with another fuel spray; and

FIG. 21 is a plan view schematically illustrating the merged fuel sprays being pulled to a far edge of the helical end sections.

### DETAILED DESCRIPTION OF THE INVENTION

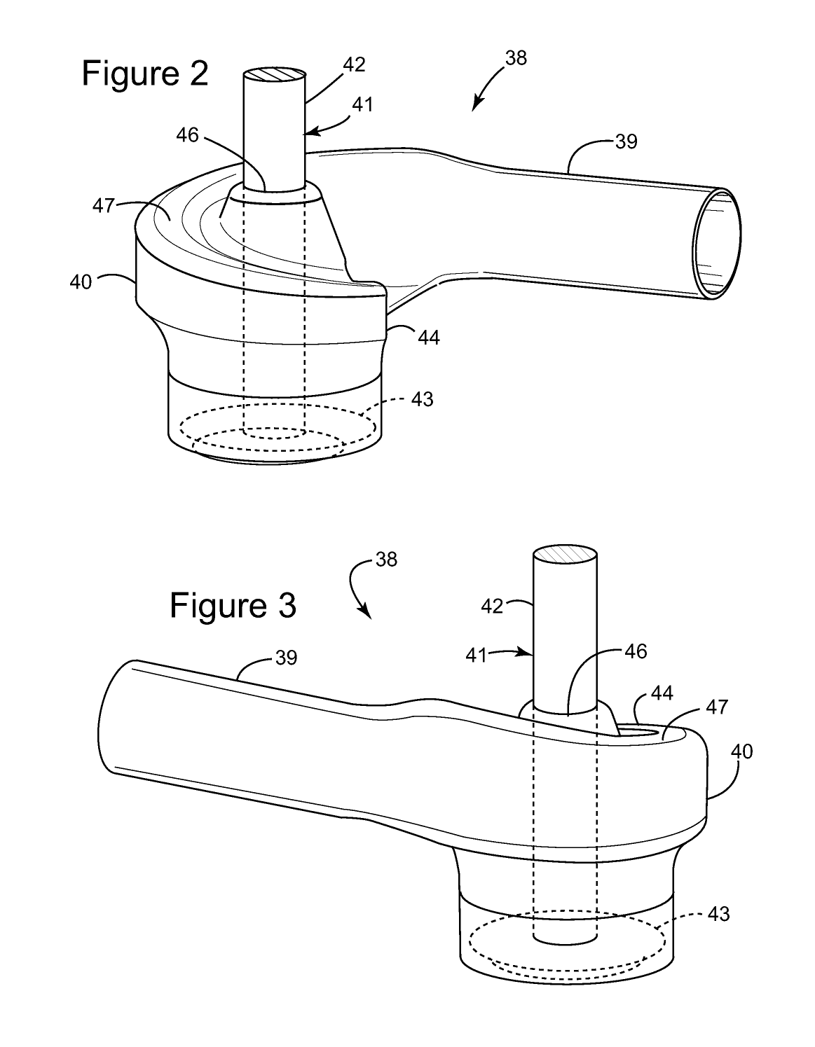

Referring to FIGS. 2 and 3, for purposes of clarity, a helical passage 38 (as referred to herein) is a connecting passage (port), which typically links an inlet manifold to an inlet valve of a cylinder head in a conventional engine. The downstream portion of the helical passage 38 includes a generally straight runner section 39 integrally connected to a helical end section 40, which is disposed over an inlet valve 41. The inlet valve 41 includes a stem 42 and a head 43, wherein the head 43 opens to a cylinder (not shown). The flow area within the helical end section 40 is disposed in a circumferential and descending funnel 44 around the valve stem 42, which is carried in a bore 46 of the end section 40. The funnel 44 spirals over at least one-third of a turn, and preferably between one-half and three-quarters of a turn, about the valve stem 42, so that incoming air is forced to rotate about the valve stem 42 prior to entering the cylinder. The roof 47 of the funnel 44 reduces in height as the funnel 44 spirals around the valve stem 42.

The runner section 39 can optionally be oriented tangentially or radially relative to the cylinder, such orientation determining the bulk flow direction of the fuel/air charge as it enters the cylinder. Also, optionally, each helical end section 40 may spiral in a clockwise or counterclockwise direction, such rotational direction determining the direction of rotation or spin the fuel/air charge will have as it enters the cylinder.

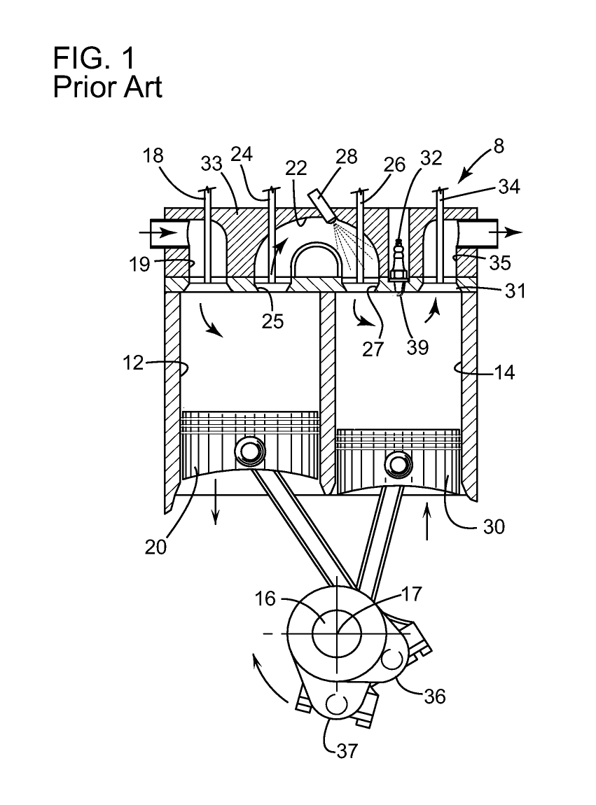

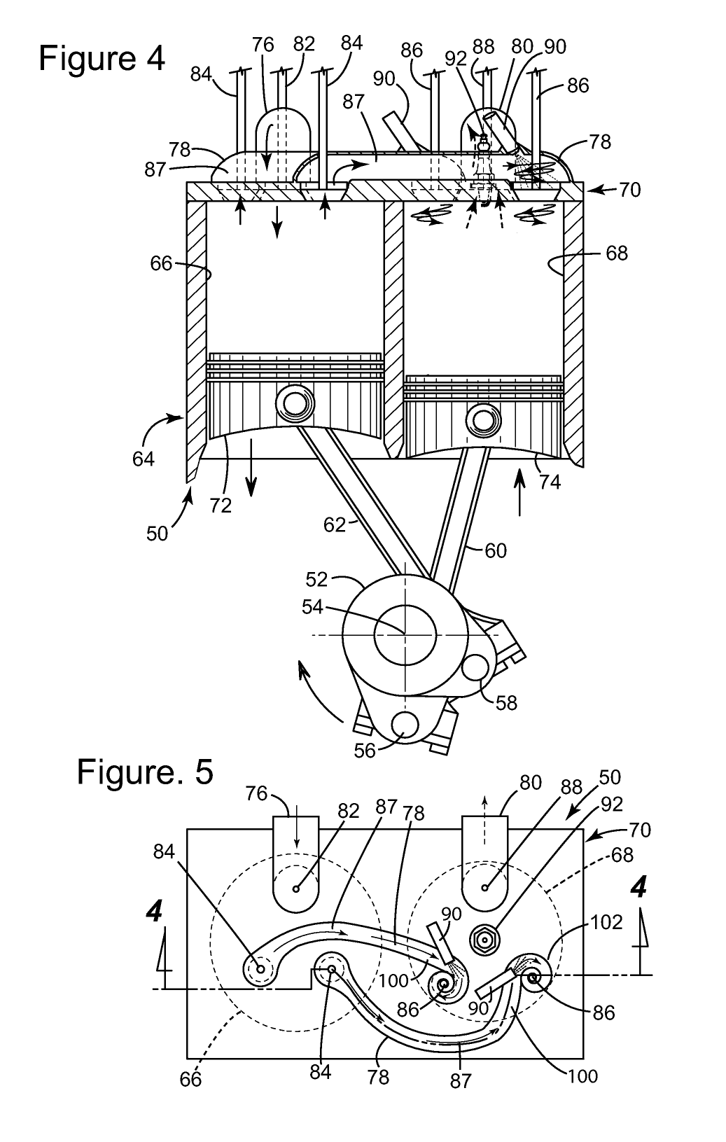

Referring to FIGS. 4 and 5, numeral 50 generally indicates an exemplary embodiment of a split-cycle engine having dual tangential helical crossover passages 78 with a fuel injector 90 disposed in the downstream portion of each crossover passage 78 in accordance with the present invention. Split-cycle engine 50 is functionally and structurally similar to prior art split-cycle engine 8 as illustrated and described in FIG. 1.

Engine 50 includes a crankshaft 52 rotatable about a crankshaft axis 54 in a clockwise direction as shown in the figures. The crankshaft 52 includes adjacent angularly displaced leading and following crank throws 56, 58 connected to connecting rods 60, 62, respectively.

Engine 50 further includes a cylinder block defining a pair of adjacent cylinders. In particular, engine 50 includes a compression cylinder 66 and an expansion cylinder 68 closed by a cylinder head 70 at an upper end of the cylinders opposite the crankshaft 52.

A compression piston 72 is received in compression cylinder 66 and is connected to the following connecting rod 62 for reciprocation of the piston 72 between top dead center (TDC) and bottom dead center (BDC) positions. An expansion piston 74 is received in expansion cylinder 68 and is connected to the leading connecting rod 60 for similar TDC/BDC reciprocation.

The cylinder head 70 provides the structure for gas flow into, out of, and between the cylinders 66, 68. In the order of gas flow, the cylinder head 70 includes an intake passage 76 through which intake air is drawn into the compression cylinder 66, a pair of tangential helical crossover (Xovr) passages 78 through which compressed air is transferred from the compression cylinder 66 to the expansion cylinder 68, and an exhaust passage 80 through which spent gases are discharged from the expansion cylinder 68.

Gas flow into the compression cylinder 66 is controlled by an inwardly opening poppet type intake valve 82. Gas flow into and out of each helical crossover passage 78 may be controlled by a pair of outwardly opening poppet valves, i.e., crossover compression (XovrC) valves 84 at inlet ends of the helical crossover passages and crossover expansion (XovrE) valves 86 at outlet ends of the helical crossover passages. Each pair of crossover valves 84, 86 defines a pressure chamber 87 between them in their respective crossover passages. Exhaust gas flow out the exhaust passage 80 is controlled by an inwardly opening poppet type exhaust valve 88. These valves 82, 84, 86 and 88 may be actuated in any suitable manner, such as by mechanically driven cams, variable valve actuation technology, or the like.

Each helical crossover passage 78 has at least one high pressure fuel injector 90 disposed therein. The fuel injectors 90 are operative to inject fuel into the charge of compressed air within the pressure chambers 87 of the helical crossover passages 78.

Engine 50 also includes one or more spark plugs 92 or other ignition devices. The spark plugs 92 are located at appropriate locations in the end of the expansion cylinder 68 wherein a mixed fuel and air charge may be ignited and burned during the expansion stroke.

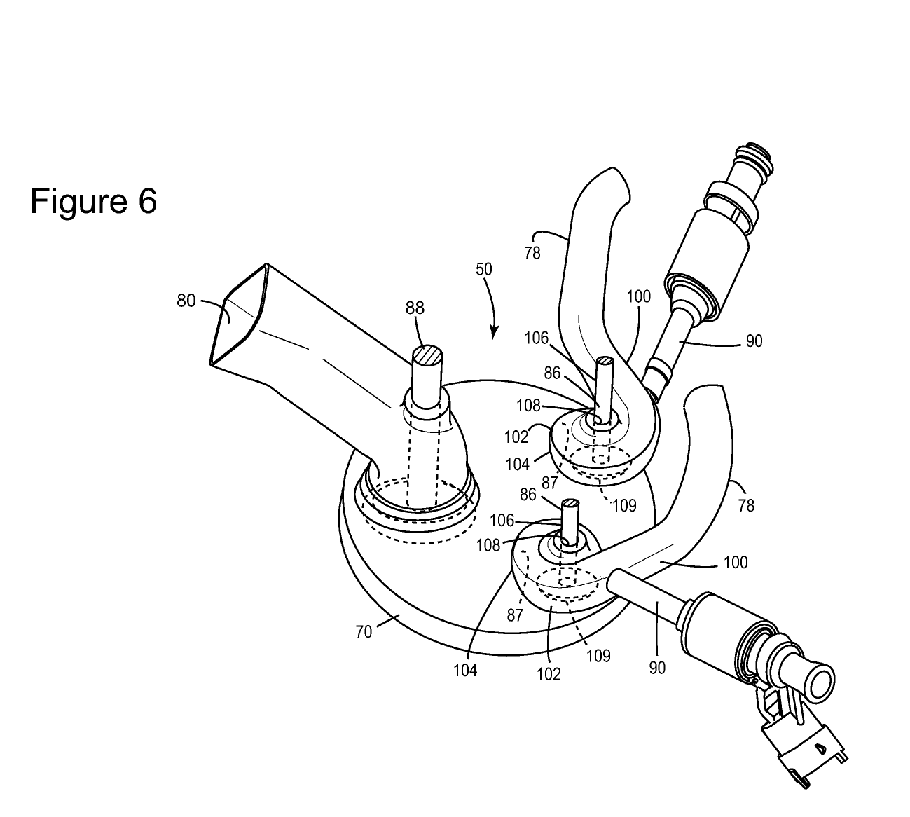

Referring to FIG. 6, a close-up view is shown of the inside of the cylinder head 70 and passages, including the exhaust passage 80 and downstream portions of the dual tangential helical crossover passages 78. Fuel injectors 90 are disposed in each downstream portion of the crossover passages 78 to inject fuel into the air stream as the XovrE valves 86 are actuated. As will be discussed in greater detail herein, the fuel spray (not shown) from the injectors 90 is targeted to optimize the flow and distribution of the fuel/air charge into the expansion cylinder 68.

As previously discussed, a fuel/air charge must flow from the crossover passages 78 into the expansion cylinder 68 where it is combusted during the expansion stroke and the products of the combustion are ultimately discharged through the exhaust passage 80 during the exhaust stroke. Prior to combustion, the fuel/air charge must be rapidly mixed and thoroughly distributed in the expansion cylinder 68.

Both crossover passages 78 are constructed with a generally straight tangential runner section 100 integrally connected to a clockwise helical end section 102, which is disposed over the outwardly opening poppet type crossover expansion valve 86.

In the embodiment of FIG. 6, each clockwise helical end section 102 includes a funnel 104 spiraling in a clockwise direction about a valve stem 106 carried in a bore 108, through which the valve stem of each outwardly opening crossover expansion valve 86 extends. The spiral funnel 104 forces incoming air to rotate about the valve stem 106 prior to entering the expansion cylinder 68. The valve stem carries an outwardly opening valve head 109, which is held closed, partially by pressure in the pressure chamber 87, when the valve is seated.

Each runner section 100 is tangential to the perimeter of the expansion cylinder 68. That is, each runner section 100 directs air flow into the funnel 104 in a flow path that is approximately parallel (i.e., preferably plus or minus 20 degrees, more preferably plus or minus 10 degrees, and most preferably plus or minus 5 degrees) to a tangential line extending through a point in the expansion cylinder's 68 perimeter which is closest to the valve stem. The valve stem 106 carries an outwardly opening valve head 109 which is held closed, partially by pressure in the pressure chamber 87, when the valve is seated. This combination of dual tangential helical crossover passages 78 in which both helical end sections 102 spiral in the same direction has been found to greatly promote rapid air/fuel mixing in the split-cycle engine 50. This embodiment depicts both helical end sections 102 spiraling in the clockwise direction; however, it may be preferable in alternative embodiments for both of the helical end sections 102 to spiral in the counterclockwise direction.

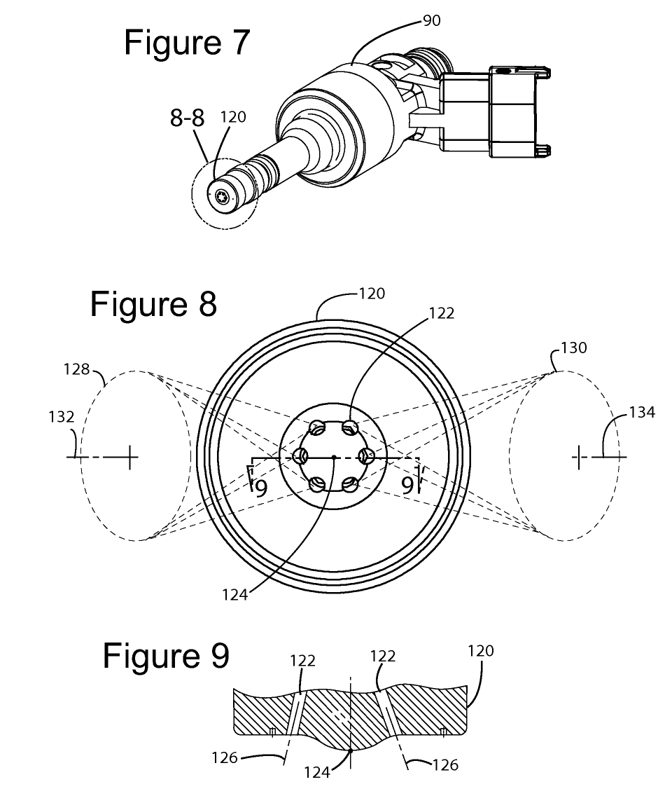

Referring to FIGS. 7, 8 and 9, a perspective view of an injector 90 is shown in FIG. 7, a close-up front view of the associated injector tip 120 of injector 90 is shown in FIG. 8 (as viewed from the line 8-8 in FIG. 7), and a close-up side view of the tip 120 is shown in FIG. 9, which is a cross-section taken along the line 9-9 in FIG. 8. In this exemplary embodiment, the injector tip 120 has a plurality of six injector spray holes 122 disposed circumferentially around an injector tip center 124 (best seen in FIG. 8). Although six injector holes are illustrated in this embodiment, any reasonable number of holes may be disposed in injector tip 120 (e.g., 1 through 8 or more). Each injector spray hole 122 may vary in diameter and/or length, and each hole 122 has a spray hole centerline 126 extending therethrough (best seen in FIG. 9).

It is important to note that the spray hole centerlines 126 of holes 122 each may be substantially independently oriented (aimed) to direct fuel at a separate individual target or at a plurality of common targets within the geometry of the engine 50. That is, the holes 122 may be oriented such that, when the fuel injector 90 is mounted in engine 50, the extended centerline 126 of each hole 122 will pass generally through a specific target within the geometry of the engine 50 toward which the fuel emitting from that hole 122 will be directed. There may be as many targets as there are holes 122, or nothing more than a single target toward which all the holes 122 are aimed, or any number of targets therebetween toward which various groups of holes are aimed.

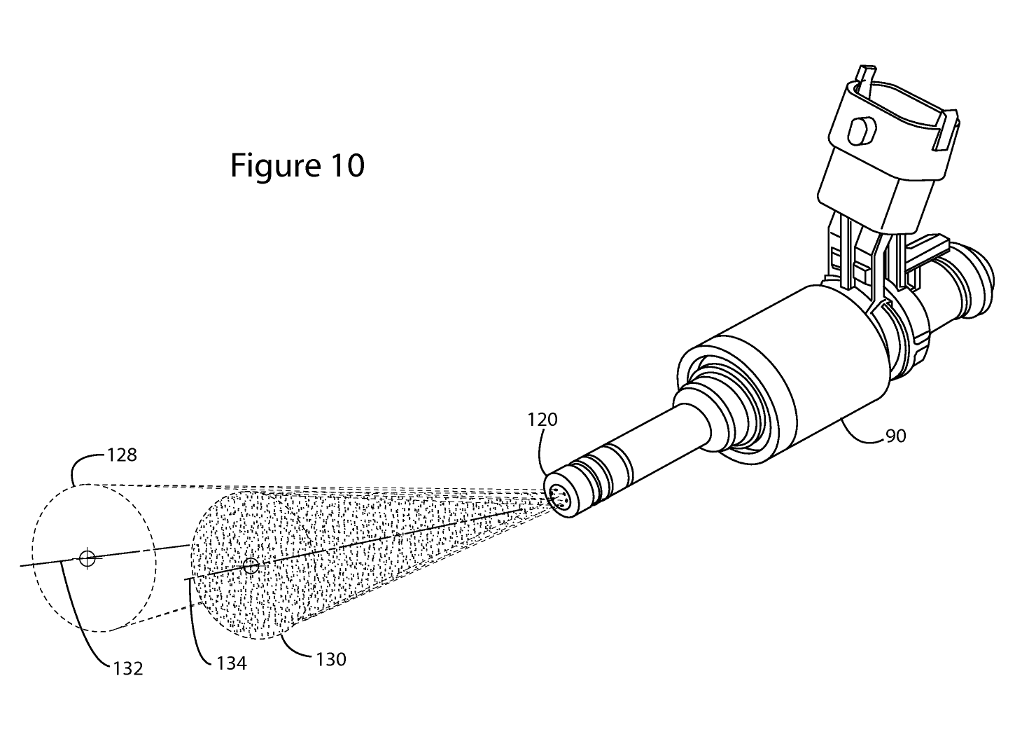

Referring to FIG. 10 and referring again to FIGS. 8 and 9, each spray hole 122 of injector 90 will emit fuel which will fan out into a generally conical fuel spray pattern (or fuel spray) as the fuel traverses away from the spray hole 122, provided there are no external forces (e.g., high air flow) acting on the fuel sprays as they are being emitted. The number of conical spray patterns may be equal to the number of targets the holes 122 are aimed at. In this exemplary embodiment, there are two targets (not shown), in which a first group of three holes is aimed at a first of the two targets and a second group of three holes is aimed at a second of the two targets. As a result, the sprays from each of the two groups of holes combine to form two distinct generally conical shaped spray patterns 128 and 130. Each spray pattern 128, 130 has a respective spray pattern centerline 132, 134, which is aimed at each target. That is, the centerlines 132, 134 extend generally from the injector tip center 124 of each injector tip 120 toward and through the target. Moreover, except for the small distance from the center of spray hole 122 to injector tip center 124, the centerline 132, 134 of each conical spray pattern 128, 130 substantially aligns with each centerline 126 of each spray hole 122 aimed at the same target.

One skilled in the art would recognize that the targets through which a plurality of spray holes 122 (and their centerlines 126) are aimed may be so close together that the fuel sprays from each of the plurality of holes 122 will combine to form a single distinct generally conical spray pattern. For purposes herein, when the sprays combine to form a single spray pattern, the holes 122 are considered to be aimed at the same target.

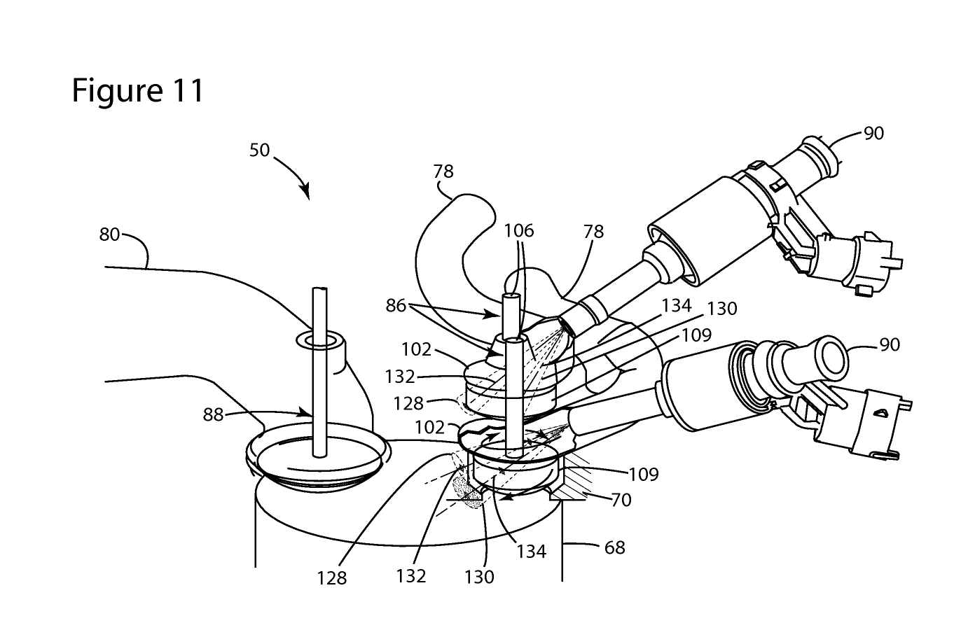

Referring to FIG. 11, a perspective view, similar to FIG. 6, is shown of the inside of the cylinder head 70 and passages, including the exhaust passage 80 and downstream portions of the dual tangential helical crossover passages 78. The fuel injectors 90 are disposed in the downstream portions of crossover passages 78. The fuel injectors 90 are activated so that they are emitting dual fuel sprays 128, 130 across the helical end sections 102 of the crossover passages 78. The dual fuel sprays 128, 130 are aimed to straddle the valve stems 106 of XovrE valves 86. The injectors are typically designed for gasoline high pressure (e.g., 20-200 bar). As such, they are designed to operate in the high pressure and high temperature environment of the Xovr ports 78.

Several factors must be considered when targeting fuel sprays from an injector for optimal fuel/air flow and distribution into expansion cylinder 68. Generally, the fuel sprays 128, 130 should be targeted to impinge as little as possible on cold surfaces and to be directed as much as possible into areas of maximum air flow. In the case of engine 50, the relatively cold surfaces to avoid are the walls of the crossover passage 78 (including the helical end sections 102) and the valve stems 106 of XovrE valves 86. The XovrE valve heads 109 have relatively hot surfaces. However, when the XovrE valve heads 109 are seated, they are generally located away from the main flow path of the air swirling in helical section 102 and should also be avoided. Accordingly, the fuel sprays 128, 130 are aimed at a target located above the seated position of the valve heads 109 and between the walls of the helical end sections 102 and the valve stems 106.

Additionally, fuel droplet size is another important factor in optimizing the fuel/air flow. Generally, large fuel droplets have greater momentum but evaporate more slowly than small fuel droplets. If the fuel droplets are too large, they may carry well into the main air flow path, but will not evaporate quickly enough and may impinge on the cool walls of the helical end section 102 where they will conglomerate as a liquid fuel and not combust properly. If the fuel droplets are too small, they will evaporate quickly, but will not have enough momentum to carry into the main air flow path and enter the expansion cylinder 68. Also generally, the larger the number of spray patterns, for a given charge (mass) of fuel, the smaller the diameter of the spray holes 122 and the smaller the droplet size.

In the exemplary embodiment of the split-cycle engine 50, dual fuel spray patterns 128, 130, having two distinct targets, worked best with regards to optimizing the droplet sizes. That is, a single spray pattern would produce droplets that were too big and would impinge too much on the cool surfaces of the helical end sections 102. Alternatively, three or more spray patterns would produce droplets that were too small and would not have enough momentum to carry across the helical end section 102 and mix with the main air flow path entering the expansion cylinder 68.

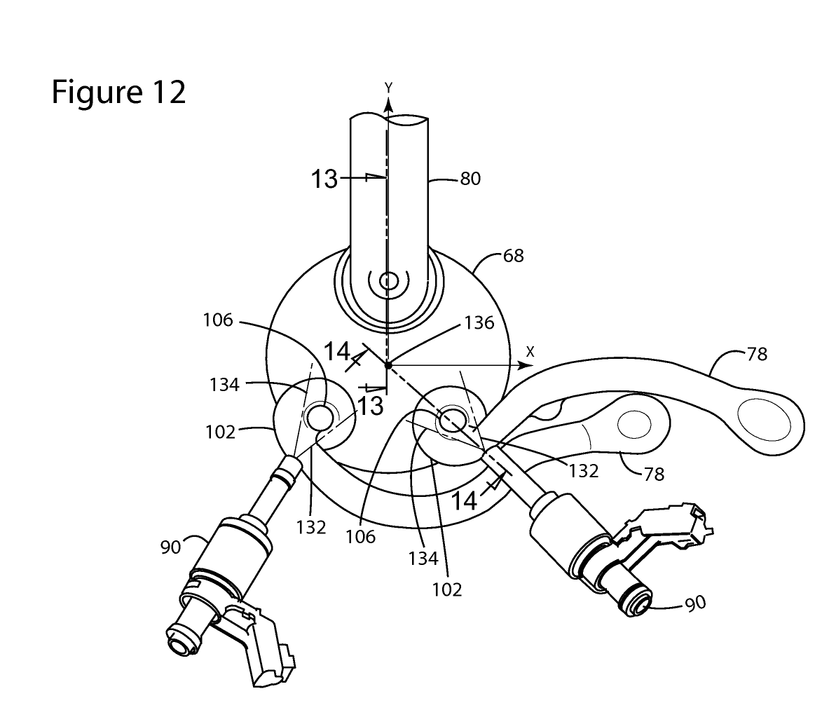

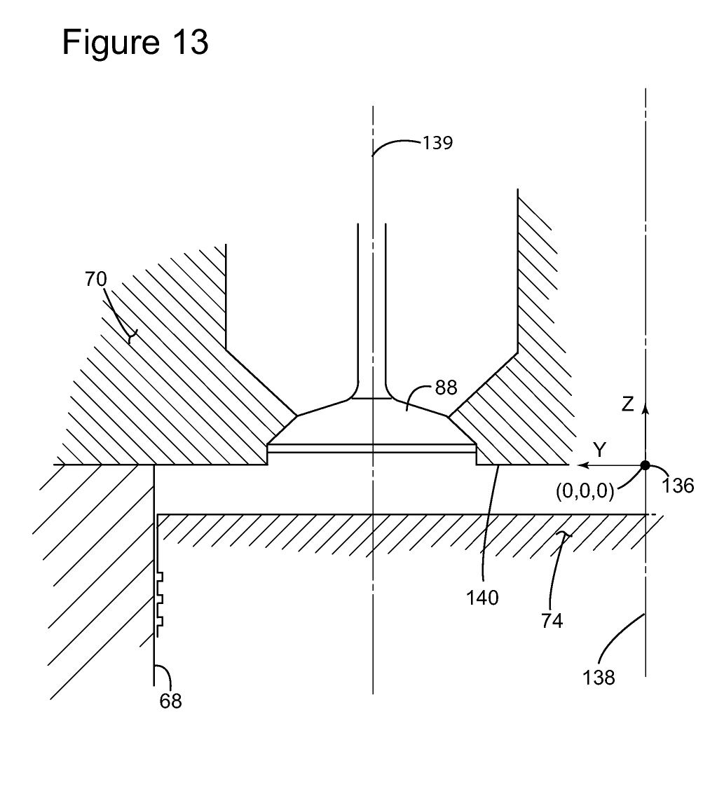

Referring to FIGS. 12 and 13, a three-dimensional Cartesian coordinate system (having X, Y and Z coordinates) is superimposed over the engine 50, and more specifically, over the expansion cylinder 68. FIG. 12 illustrates the Y-X plane (i.e., where Z=0) of the coordinate system. FIG. 13 is a cross-sectional view taken along the line 13-13 in FIG. 12, and FIG. 13 illustrates the Y-Z plane (i.e., where X=0) of the coordinate system. The Y-Z plane passes through the centerline 138 of the expansion cylinder 68 as well as the centerline 139 of the exhaust valve 88. The origin 136 of the coordinate system (i.e., the point where X, Y and Z equal 0) is located at the intersection of the centerline 138 of expansion cylinder 68 (best seen in FIG. 13) and the bottom surface 140 (generally known as the firedeck or flameface) of the cylinder head 70 (also best seen in FIG. 13).

Referring to FIG. 12, it can be seen that the respective centerlines 132 and 134 of spray patterns 128 and 130, which are emitted from injectors 90, are aimed at targets located between the XovrE valve stems 106 and the walls of helical end sections 102. This is because the walls of the helical end sections 102 and the valve stems 106 of XovrE valves 86 have relatively cool surfaces and would hamper the evaporation rates of the fuel emitted from injectors 90. Note also, that if the respective centerlines 132 and 134 of the spray patterns 128 and 130 are aimed between XovrE valve stem 106 and the helical end section 102 walls, then so too are the centerlines 126 of the spray holes 122 which combine to form each associated spray pattern 128 and 130.

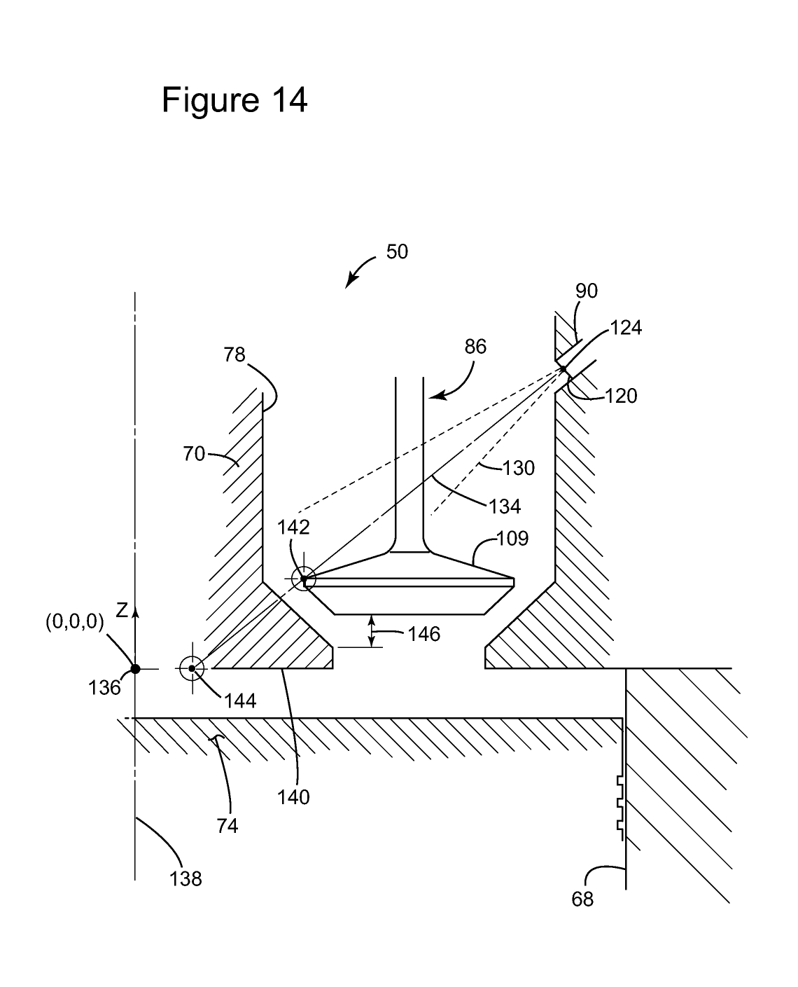

Referring to FIG. 14, which is a cross-sectional view taken along the line 14-14 in FIG. 12, for purposes of simplicity, only a single spray pattern 130 of the two spray patterns 128 and 130, which are emitted from the injector 90, is shown. As discussed earlier, spray pattern 130 has an associated centerline 134 which originates from the center 124 of injector tip 120 and is aimed (i.e., passes through) toward a target located within the engine 50 geometry. Note also, as discussed earlier, that the centerlines 126 of the spray holes 122 which combine to form spray patterns 128 and 130 are aimed at the same targets.

In this embodiment, two alternative types of targets are utilized. The first type of target is designated herein as an outside diameter (OD) target 142, and the second type of target is designated herein as a firedeck target 144. Both OD target 142 and firedeck target 144 are located at a point through which the extended centerline 134 will pass.

Both targets 142, 144 aim the centerline 134 above the XovrE valve head 109 when the valve head 109 is in its seated position. That is, both targets 142, 144 require that the valve 86 be raised a predetermined target lift distance 146 above its seated position before the maximum outside diameter of the head 109 intersects the aimed centerline 134. One of the primary reasons for selecting targets that aim the spray centerline 134 above the seated position of the XovrE valve head 109 is to inject the spray pattern 130 into an area of near maximum air flow in order to promote air/fuel mixing and distribution.

In the case of the OD target 142, the target 142 location is substantially the actual point of intersection between the maximum outside diameter of XovrE valve head 109 and the aimed centerline 134 when the XovrE valve 86 reaches its target lift distance 146. In the case of the firedeck target 144, the target 144 location is substantially at a point on the firedeck 140 of cylinder head 70 that the aimed centerline 134 would pass through after intersecting OD target 142.

The target lift distance 146 is preferably located within a range of a percentage of maximum XovrE valve 86 lift. It is preferable that the target lift distance 146 be within a range of 10 to 60 percent of maximum XovrE valve 86 lift. It is more preferable that the target lift distance 146 be within a range of 15 to 40 percent of maximum XovrE valve 86 lift. It is most preferable that the target lift distance 146 be within a range of 20 to 30 percent of maximum XovrE valve 86 lift.

By way of example, if the maximum lift of XovrE valve 86 (i.e., the point at which the XovrE valve 86 is furthest away from its seated position) is between 3.0 and 3.6 millimeters (mm) and the target lift distance 146 is set at 0.9 mm, then the lift distance 146 would be set within a desirable range of 25 to 30 percent of the maximum XovrE 86 valve lift. This would place the spray pattern 130 in good position to be swept up by the high air flow that occurs in the downstream portion of the crossover passage 78 when valve 86 opens.

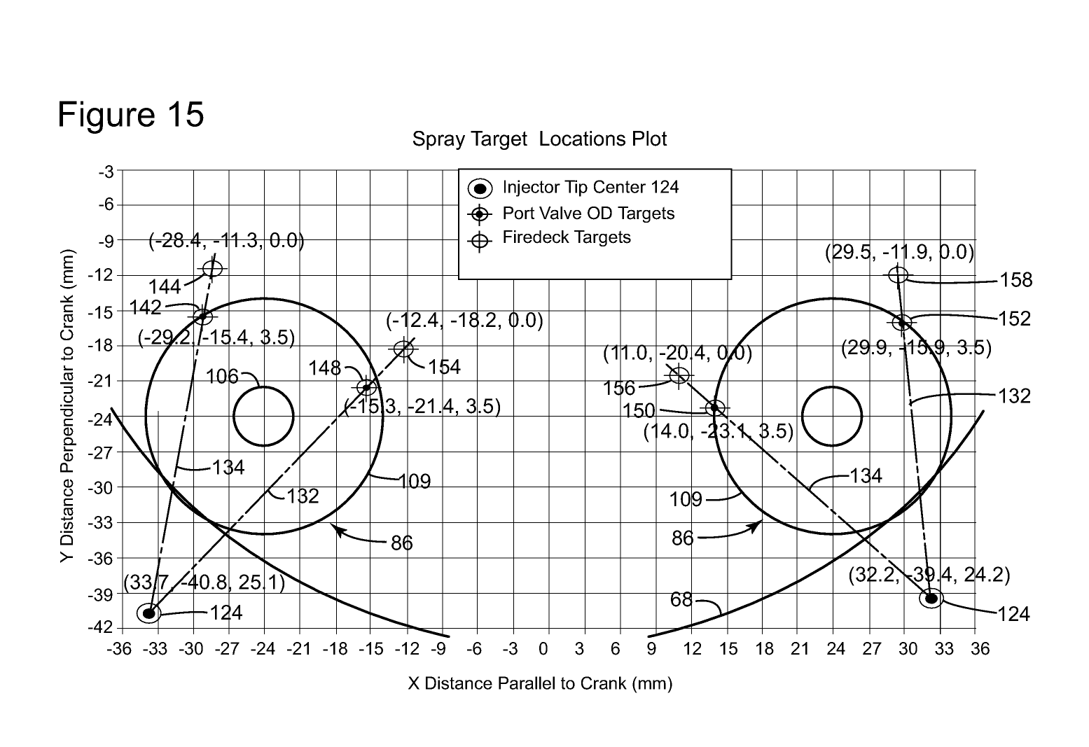

Referring to FIG. 15, an exemplary embodiment of a spray target location plot is presented showing the Cartesian coordinates (X,Y,Z) of each OD target 142, 148, 150 and 152 and each firedeck target 144, 154, 156 and 158 within the geometry of engine 50. Additionally, the coordinates for the injector spray origins (i.e., the injector tip centers 124) are also shown. For this exemplary embodiment, the target lift distance 146 is set at 0.9 mm above the seated surface of outwardly opening valves 86.

In addition to the target locations, the maximum outside diameters (OD) of heads 109 and stems 106 of XovrE valves 86 are shown relative to their positions with respect to expansion cylinder 68. Additionally, the centerlines 132 and 134 of spray patterns 128 and 130, respectively, are shown extending from the injector tip centers 124 (i.e., the injector spray origins) and passing through their associated OD targets 142, 148, 150 and 152 and firedeck targets 144, 154, 156 and 158.

In this coordinate system, the plane of Z=0 is the location of the firedeck (or flameface) 140 (best seen in FIG. 13). Accordingly, the firedeck targets 144, 154, 156 and 158 all have a Z coordinate of zero.

Also for this embodiment, when the XovrE valves 86 are seated, the maximum ODs of heads 109 are located 2.6 mm above the firedeck 140. As such, when the maximum OD of head 109 is raised the target lift distance of 0.9 mm, the maximum ODs are located 3.5 mm above the firedeck 140. Thus the OD targets 142, 148, 150 and 152 all have a Z coordinate of 3.5 mm.

Note that OD target 148 does not fall directly on the perimeter of its associated head 109. This is because of geometric obstructions in the helical end section 102 enclosing that particular head. Accordingly, the centerline 132 had to be pivoted away from the cooler wall surface of helical end section 102 and closer to the hotter stem 106. Technically this means that the projected centerline 132 intersects the maximum OD of head 109 at a point that is slightly less than the desired target lift distance of 0.9 mm. However, the sacrifice in target lift distance 146 is small and well within the preferred range of between 10 to 60 percent of maximum lift of valve 86.

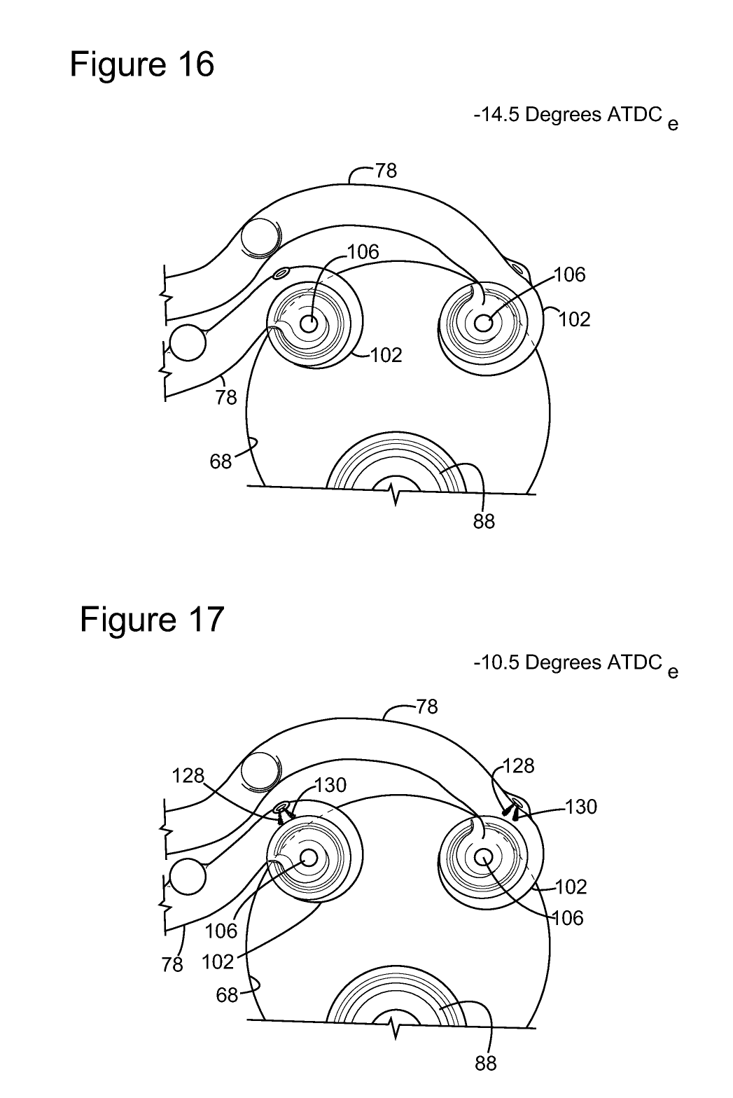

Referring to FIGS. 16-21, the fuel delivery event per degrees of crank angle rotation is shown in detail. The number in the top right of each figure is the crank angle location of the expansion piston 74 in degrees after top dead center of the expansion piston 74 (ATDCe).

The injectors 90 are mounted on the outsides of the helical end sections 102, but are targeted so the spray is carried by the air flow across and around the helical end sections 102 towards the insides of the helical end sections 102. As such, the air-fuel mixtures mostly exit through the XovrE valve 86 openings towards the center of the expander cylinder 68 and are carried across the cylinder 68.

Referring to FIG. 16, at −14.5 degrees ATDCe, the injection event has not yet begun. Additionally, the XovrE valves 86 are still in their seated position.

Referring to FIG. 17, at −10.5 degrees ATDCe, the injection event has begun prior to XovrE valve 86 opening, so that there is time for the fuel sprays 128, 130 to travel across the helical end sections 102 before the valves 86 open. Although the injection event typically starts (i.e., the start of fuel injection into the crossover passages 78) before the XovrE valve 86 opens, there are operating conditions wherein the injection event may start after the XovrE valves 86 begin to open.

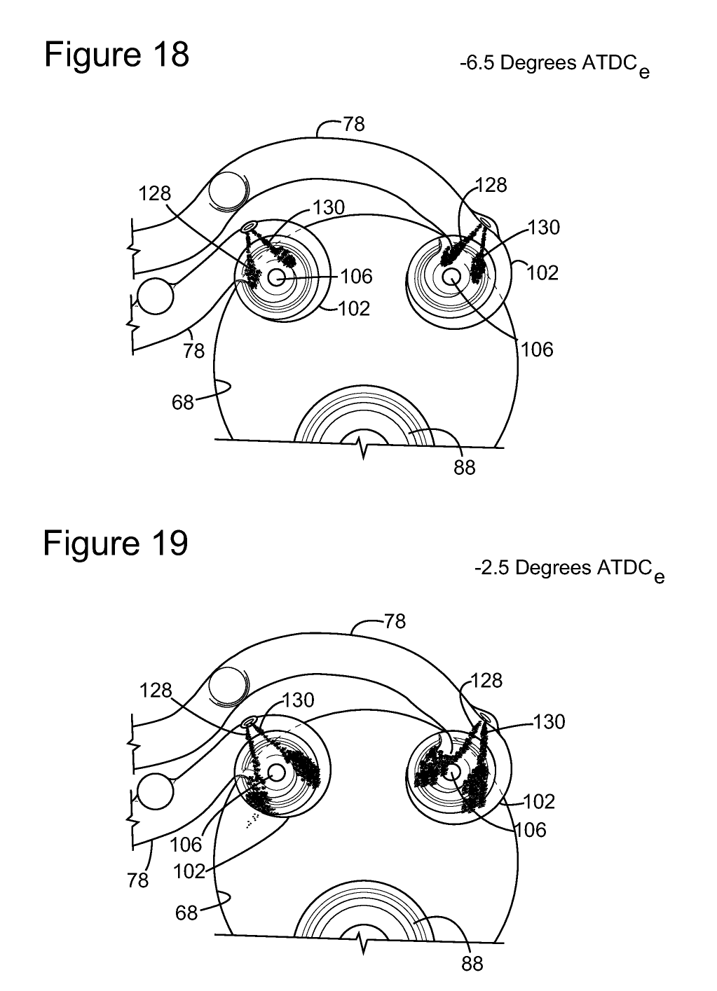

Referring to FIG. 18, at −6.5 degrees ATDCe, the XovrE valves 86 have lifted enough so that a substantial amount of air flow has been established and is beginning to affect the trajectory of the sprays 128 and 130. The two sprays 128 and 130 are still substantially straddling the valve stems 106.

Referring to FIG. 19, at −2.5 degrees ATDCe, the two sprays 128 and 130 have reached almost fully across the helical end sections 102 and are still straddling the stems 106. However, there is a fair amount of distortion in the trajectory of the sprays 128 and 130 as they are being swept up into the air flow swirling around the helical end section 102.

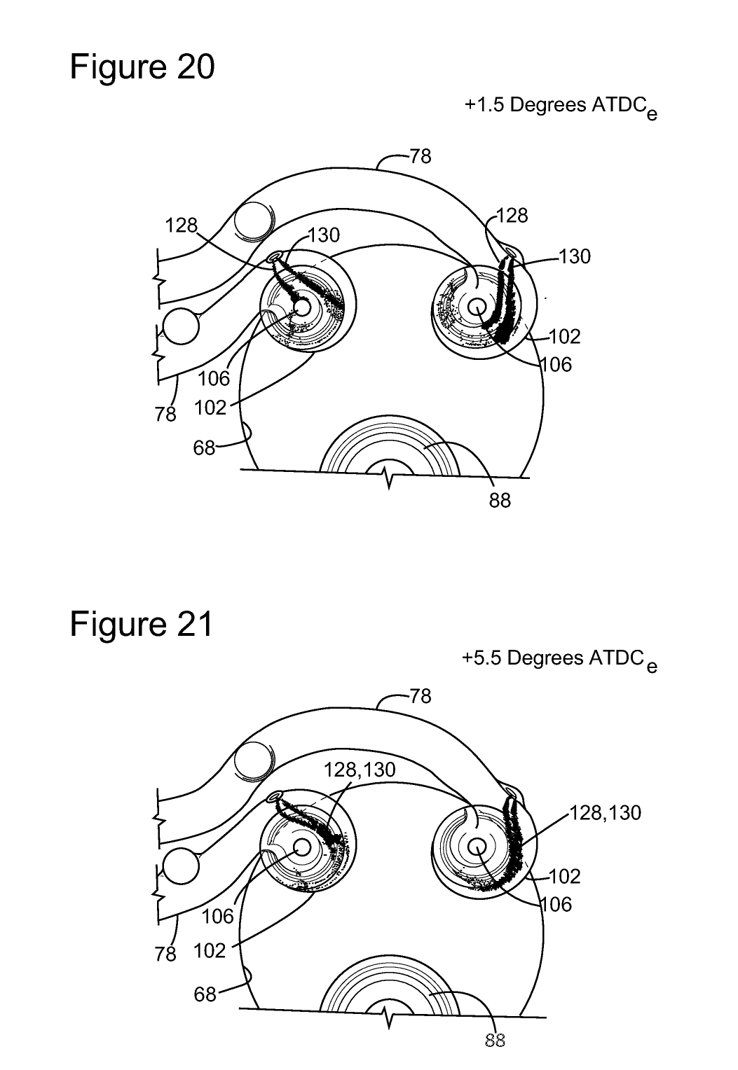

Referring to FIG. 20, at +1.5 degrees ATDCe, spray pattern 128 on the left injector is being pulled by the air flow to the point where it is just crossing its associated valve stem 106. The spray pattern 128 on the right injector has been pulled fully across its associated stem 106 and is beginning to merge with its associated spray pattern 130.

Referring to FIG. 21, at +5.5 degrees ATDCe, the sprays 128 and 130 from both injectors 90 have been pulled by the swirling air flow to the far edge of the helical end sections 102, and have merged together. The combined fuel sprays 128 and 130 are now exiting through the XovrE valve 86 openings towards the center of the expander cylinder 68 and are being carried across the cylinder 68.

The injection events end prior to XovrE valve 86 closing, so that there is time for the remaining air flow through the XovrE valves 86 to carry out the majority of the injected fuel. Typically the duration of the ejection event is 45 degrees of crank angle or less, preferably 40 degrees of crank angle or less, and more preferably 35 degrees of crank angle or less. This also helps to minimize the possibility for fuel to partially combust in the crossover passages 78.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. An engine comprising:
a crankshaft rotatable about a crankshaft axis;
an expansion piston slidably received within an expansion cylinder and operatively connected to the crankshaft such that the expansion piston is operable to reciprocate through an expansion stroke and an exhaust stroke during a single rotation of the crankshaft;
a crossover passage including walls, the crossover passage connecting a source of high pressure gas to the expansion cylinder;
a crossover expansion (XovrE) valve operable to control fluid communication between the crossover passage and the expansion cylinder, the XovrE valve including a valve head and a valve stem extending from the valve head; and
a fuel injector operable to inject fuel into the crossover passage;
the fuel injector including a plurality of spray holes disposed in a nozzle end of the fuel injector and aimed at an at least one target at which fuel emitting from the spray holes is directed to form at least one spray pattern;
wherein the at least one target is located above a seated position of the XovrE valve head and between the walls of the crossover passage and the XovrE valve stem.

2. The engine of claim 1, wherein the spray holes are aimed at a plurality of spray targets to form a plurality of spray patterns, the targets located such that the spray patterns straddle the valve stem of the XovrE valve.

3. The engine of claim 1, wherein each spray hole has a centerline extending therethrough, the plurality of spray holes being oriented such that the spray hole centerlines pass through the at least one target at which the spray holes are aimed.

4. The engine of claim 3, wherein one of the at least one target is an outside diameter target located at a point on the centerline of one spray hole of the plurality of spray holes at which said centerline intersects a maximum outside diameter of the XovrE valve head when the XovrE valve is raised a predetermined target lift distance above its seated position.

5. The engine of claim 4, wherein the target lift distance is within a range of 10 to 60 percent of maximum XovrE valve lift.

6. The engine of claim 4, wherein the target lift distance is within a range of 15 to 40 percent of maximum XovrE valve lift.

7. The engine of claim 4, wherein the target lift distance is within a range of 20 to 30 percent of maximum XovrE valve lift.

8. The engine of claim 3, wherein the spray hole centerlines are substantially independently oriented.

9. The engine of claim 1, wherein the number of spray patterns equals the number of spray targets.

10. The engine of claim 1, wherein the crossover passage is a helical crossover passage including a helical end section disposed over the XovrE valve, and wherein the at least one target is located within the helical end section.

11. The engine of claim 10, wherein the helical end section spirals in one of a clockwise or a counterclockwise direction.

12. The engine of claim 1, wherein the XovrE valve is an outwardly opening valve.

13. The engine of claim 1, wherein:
the source of high pressure gas is a compression cylinder including a compression piston slidably received therein, the compression cylinder being operatively connected to the crankshaft such that the compression piston is operable to reciprocate through an intake stroke and a compression stroke during a single rotation of the crankshaft; and
the crossover passage interconnects the expansion and compression cylinders.

14. An engine comprising:
a crankshaft rotatable about a crankshaft axis;
an expansion piston slidably received within an expansion cylinder and operatively connected to the crankshaft such that the expansion piston is operable to reciprocate through an expansion stroke and an exhaust stroke during a single rotation of the crankshaft;
a crossover passage connecting a source of high pressure gas to the expansion cylinder;
a crossover expansion (XovrE) valve operable to control fluid communication between the crossover passage and the expansion cylinder, the XovrE valve including a valve stem; and
a fuel injector operable to inject fuel into the crossover passage;
the fuel injector including a plurality of spray holes disposed in a nozzle end of the fuel injector, the spray holes being aimed at two or more targets at which fuel emitting from the spray holes is directed to form at least two fuel sprays;
wherein the at least two fuel sprays straddle the valve stem of the XovrE valve.

15. The engine of claim 14, wherein each spray hole has a centerline extending therethrough, the plurality of spray holes being oriented such that each spray hole centerline passes through one said target at which fuel is directed.

16. The engine of claim 15, wherein the centerlines of the spray holes forming one said spray pattern are oriented at a target that is distinct from a target at which the centerlines of the spray holes forming another said spray pattern are oriented.

17. The engine of claim 15, wherein:
the XovrE valve includes a valve head disposed at an end of the valve stem, and
one of the targets is an outside diameter target located at a point on the centerline of at least one said spray hole at which said centerline intersects a maximum outside diameter of the XovrE valve head when the XovrE valve is raised a predetermined target lift distance above its seated position.

18. The engine of claim 17, wherein the target lift distance is within a range of 10 to 60 percent of maximum XovrE valve lift.

19. The engine of claim 17, wherein the target lift distance is within a range of 15 to 40 percent of maximum XovrE valve lift.

20. The engine of claim 17, wherein the target lift distance is within a range of 20 to 30 percent of maximum XovrE valve lift.

21. The engine of claim 14, wherein the crossover passage is a helical crossover passage including a helical end section disposed over the XovrE valve, and wherein the two or more targets are located within the helical end section.

22. The engine of claim 21, wherein the helical end section spirals in one of a clockwise or a counterclockwise direction.

23. The engine of claim 14, wherein the XovrE valve is an outwardly opening valve.

24. The engine of claim 14, wherein:
the source of high pressure gas is a compression cylinder including a compression piston slidably received therein, the compression cylinder being operatively connected to the crankshaft such that the compression piston is operable to reciprocate through an intake stroke and a compression stroke during a single rotation of the crankshaft; and
the crossover passage interconnects the expansion and compression cylinders.

25. A method of injecting fuel in an engine; the engine including a crankshaft rotatable about a crankshaft axis; an expansion piston slidably received within the expansion cylinder and operatively connected to the crankshaft such that the expansion piston is operable to reciprocate through an expansion stroke and an exhaust stroke during a single rotation of the crankshaft; a crossover passage including walls and connecting a source of high pressure gas to the expansion cylinder; a crossover expansion (XovrE) valve disposed at an outlet end of the crossover passage and operable to control fluid communication between the crossover passage and the expansion cylinder, the XovrE valve including a valve head and a valve stem extending from the valve head; and a fuel injector operable to inject fuel into the crossover passage; the fuel injector including a plurality of spray holes disposed in a nozzle end of the fuel injector; the method comprising:
aiming each spray hole at one of two targets at which fuel emitting from the spray holes is directed to form two spray patterns, the two targets being located above a seated position of the XovrE valve head and between walls of the crossover passage and the XovrE valve stem such that the spray patterns straddle the XovrE valve stem;
beginning to inject fuel from the fuel injector towards the outlet end of the crossover passage;
opening the XovrE valve; and
ending injection of fuel prior to closing the opened XovrE valve.

26. The method of claim 25, wherein fuel injection is begun before opening the XovrE valve.

27. The method of claim 25, wherein fuel injection is begun after opening the XovrE valve.

28. The method of claim 25, including the steps of:
establishing air flow from the crossover passage to the expansion cylinder through the open XovrE valve;
sweeping the two spray patterns into the air flow such that one said spray pattern is pulled over and across the XovrE valve stem and is merged with the other said spray pattern to generally form a single combined spray.

29. The method of claim 28, including the step of:
pulling the combined spray towards an edge of the outlet end of the crossover passage whereby the combined spray exits the crossover passage through the XovrE valve.

30. The method of claim 25, wherein the XovrE valve is opened outwardly relative to the expansion cylinder.

31. The method of claim 25, wherein a duration of an injection event from the beginning of fuel injection to the ending of fuel injection is approximately 45 degrees of crank angle or less.

32. The method of claim 25, wherein a duration of an injection event from the beginning of fuel injection to the ending of fuel injection is approximately 40 degrees of crank angle or less.

33. The method of claim 25, wherein a duration of an injection event from the beginning of fuel injection to the ending of fuel injection is approximately 35 degrees of crank angle or less.
